(19) United States
(12) Patent Application Publication
(10) Pub. No.: US 2017/0103563 A1
(43) Pub. Date: Apr. 13, 2017

(54) METHOD OF CREATING AN ANIMATED REALISTIC 3D MODEL OF A PERSON

(71) Applicants: Victor Erukhimov, Moscow (RU); Ilya Lysenkov, Nizhny Novgorod (RU)

(72) Inventors: Victor Erukhimov, Moscow (RU); Ilya Lysenkov, Nizhny Novgorod (RU)

(21) Appl. No.: 15/288,068

(22) Filed: Oct. 7, 2016

Related U.S. Application Data
(60) Provisional application No. 62/238,526, filed on Oct. 7, 2015.

(51) Int. Cl. G06T 13/40; G06T 15/04; G06T 17/20

(52) U.S. Cl. CPC G06T 13/40; G06T 17/20; G06T 15/04; G06T 2207/20

(57) ABSTRACT

The present invention provided a method for animating 3D models of people.

### CROSS REFERENCE TO RELATED APPLICATIONS

This application claims the benefit of U.S. Provisional Application No. 62/238,526, filed Oct. 7, 2015, the entire content of which is incorporated by reference.

### BACKGROUND OF THE INVENTION

Field of Invention

The present invention relates to a method for animating 3D models of people.

We have been working on the problem of an app that enables consumers to create animated 3D models of real people. The process involves scanning a person to create a static 3D model, and then creating a rigged model [1] that can be used in games and virtual reality (VR) social apps. These applications require very high level of quality for a 3D model. We realized that consumer 3D scanning won't give us the level of quality we need for the final result. First of all, the consumer scanning devices have limited accuracy and can't scan small objects like fingers. Also, consumers also are not good in scanning small scale details. So we came up with a method that gives a much greater level of detail without imposing strong requirements on the static 3D scan. The main idea is to adjust the shape of a parametric rigged model to look like the static scanned 3D model, and then transfer the texture from the static 3D model to the parametric rigged model.

There is a choice of parametric models for human body, with SCAPE model [1′] as the most popular by now but also there are recent advances (e.g. [2′]). SCAPE model was used before for scanning as a way to produce a 3D model from raw data, it can be RGB data [3′, 4′] or depth data [1′, 5′]. In our case we don't apply a parametric model to raw data but rather use the scanned 3D model. This way we get much better data to work with (e.g. noise inherent in raw depth data is smoothed out in the scanned model) and also utilize global information not available in individual frames (e.g. now we have continuous surface instead of individual points in raw depth data). This result in a better quality fit of parameters and allows us not only produce a rigged model but also to get more detailed 3D shape. Secondly, the previous approaches don't produce textured models. In our case the final model has high-quality texture which is essential for digital applications like animation.
[1′] Anguelov, D., Srinivasan, P., Koller, D., Thrun, S., Rodgers, J., & Davis, J. (2005, July). SCAPE: shape completion and animation of people. In ACM Transactions on Graphics (TOG) (Vol. 24, No. 3, pp. 408-416). ACM.
[2′] Zuffi, S., & Black, M. J. (2015). The Stitched Puppet: A Graphical Model of 3D Human Shape and Pose. In Proceedings of the IEEE Conference on Computer Vision and Pattern Recognition (pp. 3537-3546).
[3′] B\check{a}lan, A. 0., Sigal, L., Black, M. J., Davis, J. E., & Haussecker, H. W. (2007, June). Detailed human shape and pose from images. In Computer Vision and Pattern Recognition, 2007. CVPR'07. IEEE Conference on (pp. 1-8). IEEE.
[4′] B\check{a}lan, A. 0., & Black, M. J. (2008). The naked truth: Estimating body shape under clothing. In Computer Vision—ECCV 2008 (pp. 15-29). Springer Berlin Heidelberg.
[5′] Weiss, A., Hirshberg, D., & Black, M. J. (2011, November). Home 3D body scans from noisy image and range data. In Computer Vision (ICCV), 2011 IEEE International Conference on (pp. 1951-1958). IEEE.

### SUMMARY OF THE INVENTION

The present invention solves the problem of creating an animated body model (rig) of a real person by using its static 3D model. We scan a person in A-pose or T-pose to create a static 3D model. Then we define a parameterized rig, where rig parameters change body shape. We consider a rig in the corresponding pose (A-pose or T-pose) and find the parameters that result in the best likeness of a rig model and the person 3D model. Although we will be discussing the full body rig, the same method can be applied to creating a rig of other objects, including human face.

We start with a static 3D model. A 3D model is described by 3D points, mesh that is defined as polygons with vertices coinciding with 3D points, and a texture with UV mapping [2]. However, instead of animating this model like methods [3, 4], we use a reference 3D model. A reference 3D model is a rigged model of a human body that has parameters defining its shape. These parameters impact the human body metrics such as height, waistline, hipline, arm length, knee circumference and other parameters. The approach is suitable for different parametric body models, including, but not limited to [7, 8]. We use such a parameterized model to create a personalized rig from a 3D scan. Here is the description of this method:
1. Put the reference model in A-shape or T-shape, corresponding to the shape the static 3D model was scanned in.
2. Define a cost function for the likeness between the two models. Here is one example of such a cost function. Let pᵢ be 3 dimensional points that correspond to vertices of the reference model mesh, that is parameterized by a vector T, and qᵢ—of the static 3D model. Let \tilde{q}ᵢ=N(pᵢ) be the function that for each point from the reference model returns the closest mesh point of the static input 3D model. Then the cost function is defined as: C(T)−Σᵢ(qᵢ−N(pᵢ))².
3. Find the set of parameters T that minimizes the cost function. Any optimization algorithm can be used, we use Levenberg-Marquardt method [5, 6].
4. Once the optimal parameters are set, we use the mapping N(pᵢ) to calculate the UV texture mapping for the reference model given the UV mapping for the static model. If raw RGB images are available we utilize them for texture mapping of the reference model by using the reference model as a mesh in a 3D reconstruction pipeline. As a result, we have a rigged model with shape similar to the scanned static 3D model and texture mapped from the static 3D model or raw RGB data. Alternatively, only a head can be textured this way but a predefined texture is used for the rest of the body. This is achieved by modeling texture for a reference model and by keeping UV mapping constant when changing body model parameters. This creates plausible scaling of texture for different body shapes and produces excellent texture for the body and the realistic texture for the face.

### REFERENCES

[1] https://en.wikipedia.org/wiki/Skeletal_animation
[2] https://en.wikipedia.org/wiki/UV_mapping
[3] Baran, I., & Popović, J. (2007, August). Automatic rigging and animation of 3d characters. In ACM Transactions on Graphics (TOG) (Vol. 26, No. 3, p. 72). ACM.
[4] Lopez, R., & Poirel, C. (2013, July). Raycast based auto-rigging method for humanoid meshes. In ACM SIGGRAPH 2013 Posters (p. 11). ACM.
[5] Kenneth Levenberg (1944). “A Method for the Solution of Certain Non-Linear Problems in Least Squares”. Quarterly of Applied Mathematics 2: 164-168.
[6] Marquardt, D. W. (1963). An algorithm for least-squares estimation of nonlinear parameters. Journal of the Society for Industrial & Applied Mathematics, 11(2), 431-441.
[7] Anguelov, D., Srinivasan, P., Koller, D., Thrun, S., Rodgers, J., & Davis, J. (2005, July). SCAPE: shape completion and animation of people. In ACM Transactions on Graphics (TOG) (Vol. 24, No. 3, pp. 408-416). ACM.
[8] Zuffi, S., & Black, M. J. (2015). The Stitched Puppet: A Graphical Model of 3D Human Shape and Pose. In Proceedings of the IEEE Conference on Computer Vision and Pattern Recognition (pp. 3537-3546).

1. A method of producing a 3-dimensional model of a person's body capable of animation comprising the steps of:
a) providing a static 3D model of a person's body defined as polygons with vertices represented as 3D points and a texture with UV mapping;
b) defining a cost function between the static 3D model and a reference 3D model;
c) determining a set of parameters T that minimizes the cost function; and
d) calculating the UV texture mapping for the reference model given the UV mapping for the static model.
